(19) United States
(12) Patent Application Publication
(10) Pub. No.: US 2020/0212710 A1
(43) Pub. Date: Jul. 2, 2020

(54) METHOD FOR PREDICTING OPERATION STATE OF POWER DISTRIBUTION NETWORK WITH DISTRIBUTED GENERATIONS BASED ON SCENE ANALYSIS

(71) Applicant: SOUTHEAST UNIVERSITY, Jiangsu (CN)

(72) Inventors: Wei GU, Jiangsu (CN); Shan SONG, Jiangsu (CN); Suyang ZHOU, Jiangsu (CN); Zhi WU, Jiangsu (CN)

(73) Assignee: SOUTHEAST UNIVERSITY, Jiangsu (CN)

(21) Appl. No.: 16/639,744

(22) PCT Filed: Apr. 27, 2018
(86) PCT No.: PCT/CN2018/084936

§ 371 Date: Feb. 18, 2020

(30) Foreign Application Priority Data
Sep. 4, 2017 (CN) 201710790471.0

(51) Int. Cl. H02J 13/00; H02J 3/00; H02J 3/38

(52) U.S. Cl. CPC H02J 13/00002; H02J 3/381; H02J 3/0012

(57) ABSTRACT

A method for predicting the operation state of a power distribution network based on scene analysis is provided, comprising the following steps of step 10) obtaining the network structure and historical operation information of a power distribution system; step 20) extracting representative scene sequence fragments of output of the DGs according to historical output sequences of the DGs; step 30) obtaining a multi-scene prediction result of a future single-time section T₀ through matching the real time scene with historical similar scenes; step 40) establishing a future multi-time section operation scene tree; and step 50) deeply traversing all scenes in the future multi-time section operation scene tree, performing power distribution network load flow analysis for each scene, calculating the line current out-of-limit risk and the busbar voltage out-of-limit risk of the power distribution network, and obtaining a future operation state variation tendency of the power distribution network with the DGs.

### TECHNICAL FIELD

The present invention belongs to the field of situation awareness of power distribution network, relates to a method for predicting an operation state of a power distribution network, and more particularly relates to a method for predicting an operation state of a power distribution network with distributed generations (DGs) based on scene analysis.

### BACKGROUND ART

Situation awareness of a power distribution network with DGs is an important foundation for security, stability and economy of power system operation. Predicting the operation state of the distribution network with DG is the core link of situation awareness technology of active distribution network (ADN). Compared with the traditional power distribution network, one of the typical characteristics of the power distribution network with the DGs is the increase of the uncertainty of a power system due to the addition of the DGs, so the output prediction technology of the DGs considering the uncertainty is the crux of the matter. In existing output prediction technology of DGs, whether point forecast or probability prediction, the results do not describe the space-time correlation characteristics of output of the DGs, in addition, probability distribution information is essential in a probability method, and when the probability distribution is unknown or it is difficult to be described by the determined probability distribution, the probability prediction result can cause a deviation.

Scene analysis is an effective method to solve the stochastic problem. By simulating the possible scenes, the uncertain factors in a model are transformed into several deterministic scene problems, which reduces the difficulty of modeling and solving. Compared with traditional output prediction of DGs in which a single prediction result is obtained by time sequence prediction, the construction of a scene tree can provide a plurality of expected scenes; in addition, the scene analysis method can not only reflect the uncertainty of system operation, but also reflect the time sequence characteristics of system operation. The application of scene analysis to the operation state prediction of the power distribution network with the DGs has the feasibility and effectiveness, the historical operation information and real-time operation information of the DGs can be fully used, and a new thought is provided for the situation prediction of the power distribution network.

### SUMMARY OF THE INVENTION

### Technical Problem

The present invention provides a method for predicting an operation state of a power distribution network with DGs based on scene analysis, and by performing multi-scene prediction of multi-time section for output information of the DGs, an operation state variation tendency in the next two hours of the power distribution network is given.

### Technical Scheme

The method for predicting the operation state of the power distribution network with the DGs based on scene analysis includes the following steps:

step 10) obtaining the network structure and historical operation information of a power distribution system, wherein the historical operation information includes historical output sequences of the DGs and historical demand information of each load point;

step 20) extracting representative scene sequence fragments of output of the DGs according to the historical output sequences of the DGs;

step 30) matching the historical similar scenes by calculating a dynamic time warping distance between real-time output sequence fragments and the representative scene sequence fragments of the DGs, so as to obtain a multi-scene prediction result of a future single-time section T₀;

step 40) establishing a future multi-time section operation scene tree according to the multi-scene prediction result of the future single-time section; and

step 50) deeply traversing all scenes in the future multi-time section operation scene tree, performing power distribution network load flow analysis for each scene, calculating the line current out-of-limit risk and the busbar voltage out-of-limit risk of the power distribution network, and obtaining a variation tendency of the line current and busbar voltage out-of-limit risks under continuous time sections, namely, the future operation state variation tendency of the power distribution network with the DGs.

Furthermore, in the method of the present invention, in the step 10), node numbering is performed by traversing the network, so as to obtain the type of each node and interconnected positions of the DGs, thereby obtaining the network structure of the power distribution system.

Furthermore, in the method of the present invention, the specific process of the step 20) is as follows:

step 201) determining historical output sequence fragments, from which the representative scene sequence fragments need to be extracted, of the DG according to the prediction range of the operation state of the power distribution network, recording the length of the historical output sequence fragments as L, and determining the number M of the needed representative scene sequence fragments;

step 202) intercepting time sequence fragments with the length of L, from which the representative scene sequence fragments are to be extracted, from the historical output sequences of the DG, and recording the number of the time sequence fragments as N, so as to form a scene set;

step 203) calculating the occurrence probability p(cᵢ) of each scene sequence fragment in the scene set according to the following formula:

$$p ( {c}_{i} ) = \frac{1}{N}$$

$$i = 1 , 2 , 3 , … , N$$

wherein in the formula, cᵢ represents the i-th scene sequence fragment in the scene set, and i is a scene sequence fragment number;

step 204) for each scene sequence fragment cᵢ calculating the Kantorovich distance between the scene sequence fragment cᵢ and other scene sequence fragments according to the following formula, finding out the scene sequence fragment nearest to the scene sequence fragment cᵢ and marking it in the scene set to form a minimum scene distance matrix KD, and calculating a matrix element KD(i), corresponding to the scene sequence fragment cᵢ, in the KD according to the following formula:

KD(i)=min{∥cᵢ−cⱼ∥₂, j∈[1, 2, 3, . . . N], j≠i}, i∈[1, 2, 3, . . . N]

wherein cⱼ represents the j-th scene sequence fragment in the scene set, and j is a scene sequence fragment number;

step 205) for each scene sequence fragment cᵢ multiplying the minimum scene distance corresponding to the scene sequence fragment cᵢ by the probability of the scene sequence fragment cᵢ so as to obtain a minimum scene probability distance corresponding to the scene sequence fragment cᵢ, finding out the scene sequence fragment with the smallest minimum probability distance in the scene set as a removed scene sequence fragment c*, and removing the removed scene sequence fragment c* from the scene set, wherein the removed scene sequence fragment c* is as follows:

c*=min{KD(i)*p(i)|i∈[1, 2,3, . . . N]}

step 206) finding out the scene sequence fragment cⁿ nearest to the removed scene sequence fragment c*, and updating the probability p(cⁿ) of cⁿ according to the following formula:

p(cⁿ)=p(c*)+p(cⁿ)

step 207) setting the total number N of the scene sequence fragments as N−1, and if the total number N of the updated scene sequence fragments is M, ending the step 20), otherwise, returning to the step 204).

Furthermore, in the method of the present invention, the specific process of the step 30) is as follows:

step 301) calculating the dynamic time warping distance DTWₖ between the real-time output sequence and the k-th representative scene sequence fragment of the DG based on the representative scene sequence fragments of the output sequence of the DG extracted in the step 20); and

step 302) taking the reciprocals of the dynamic time warping distances and performing normalization treatment on the reciprocals to obtain the similarity of the real-time output sequence and the representative scene sequence fragments of the DG, taking the similarity as the occurrence probability of a corresponding prediction scene, and calculating a future predicted value Fₖ of the output sequence of the DG through the k-th representative scene sequence and the corresponding dynamic time warping distance DTWₖ, wherein M future predicted values form the multi-scene prediction result of the future single-time section T₀.

Furthermore, in the method of the present invention, the specific process of the step 40) is as follows:

step 401) incorporating the multi-scene prediction result of the future single-time section T₀ generated in the step 30) into the real-time output sequence of the DG, and obtaining a multi-scene prediction result of a next time section T′=T₀+Δt in a manner the same as that in the step 30), wherein the total number U of the results is M² and Δt is a predicted interval;

step 402) performing scene reduction for the multi-scene prediction result of the time section T′, setting the scene sequence number M′ of the time section T′ after reduction, respectively calculating the Kantorovich distances among U scene sequences to form a minimum scene distance matrix KD′, and calculating a matrix element KD′(s), corresponding to the scene sequence cₛ, in the KD′ according to the following formula:

KD′(s)=min{∥cₛ−cₜ∥₂, t∈[1, 2, 3, . . . M²], t≠s}, s∈[1, 2, 3, . . . M²]

wherein cₛ and cₜ represent the s-th scene sequence and the t-th scene sequence in the real-time output sequence set, including the predicted value F of the time section T, of the DG respectively, and s and t are scene sequence numbers;

step 403) for each scene sequence cₛ, multiplying the minimum scene distance corresponding to the scene sequence cₛ by the probability of the scene sequence cₛ to obtain a minimum scene probability distance corresponding to the scene sequence cₛ, finding out a scene sequence with the smallest minimum scene probability distance in the scene set as a removed scene sequence c\hat{ }, and removing the removed scene sequence c\hat{ } from the scene set, wherein the removed scene sequence c\hat{ } is as follows:

c\hat{ }=min{KD′(s)*p(s)|s∈[1, 2, 3, . . . M²]}

finding out the scene sequence c^{m} nearest to the removed scene sequence c\hat{ }, and updating the probability p(c^{m}) of c^{m} according to the following formula:

p(c^{m})=p(c\hat{ })+p(c^{m})

step 404) setting the total number U of the scenes as U−1, and if the total number U of the updated scenes is M′, conducting the step 405), otherwise, returning to the step 402);

step 405) if T′=T₀+n*Δt, arranging the prediction results of all the time sections in sequence of time to generate the future multi-time section operation scene tree and ending the step 40), otherwise, setting T=T′, T′=T+Δt, and M=M′, and returning to the step 401), wherein n is the number of the time sections needing predicting.

Furthermore, in the method of the present invention, the specific process of the step 50) is as follows:

step 501) deeply traversing all scenes in the future multi-time section operation scene tree, namely, regarding a predicted output value of the DG as a negative load under each scene, calculating the power distribution network load flow through forward-back substitution, and obtaining the line current and busbar voltage conditions;

step 502) based on the load flow calculation result, calculating the line overload value L_{OL}, the line overload severity S_{OL}(C/E), the voltage out-of-limit value L_{OV} and the busbar overvoltage severity S_{OV}(C/E) under each scene respectively according to the following formulas, so as to obtain the line current out-of-limit risk OLR and the busbar voltage out-of-limit risk OVR of the power distribution network, wherein

the line overload value L_{OL} is as follows:

L_{OL}=L−0.8

wherein L represents the proportion of current passing through the line to the rated current;

the line overload severity is as follows:

S_{OL}(C/E)=e^{L}^{_{OL}}−1

the line current out-of-limit risk OLR is as follows:

$$OLR = {\sum }_{i = 1}^{N L} {S}_{O L} ( C / E )$$

wherein NL is the number of the lines of the whole network;

the voltage out-of-limit value L_{OV} is as follows:

L_{OV}=|1.05−V|

wherein V is the per-unit value of node voltage;

the busbar overvoltage severity is as follows:

S_{OV}(C/E)=e^{L}^{_{OV}}−1

the busbar voltage out-of-limit risk OVR is as follows:

$$OVR = {\sum }_{i = 1}^{N P} {S}_{O V} ( C / E )$$

wherein NP is the number of nodes of the whole network;

step 503) sequentially arranging the calculation results of the step 502) from the time section T₀ to the nn-th time section to obtain the variation tendency of the line current and busbar voltage out-of-limit risks under the continuous time sections, namely the future operation state variation tendency of the power distribution network with the DGs.

### Beneficial Effects

Compared with the prior art, the present invention has the following advantages:

according to the scene analysis method provided by the present invention, the historical output information and the real-time output information of the DG are fully utilized, the ultra-short-term multi-scene prediction result of the output of the DG in the next two hours is given, and multiple development tendencies of the operation state of the power distribution network are provided by constructing the future multi-time section operation scene tree and carrying out load flow analysis on each single scene. Compared with the single-scene prediction result of the time sequence, the method provided by the present invention focuses on the occurrence possibility of the small-probability scene and the operation state variation tendency of the power distribution network after the occurrence, so that the situation awareness and the risk early warning of the power distribution network are carried out more comprehensively.

### BRIEF DESCRIPTION OF THE DRAWINGS

FIG. 1 is a flow schematic diagram of a method of an embodiment of the present invention.

FIG. 2 is a structural diagram of an IEEE-33 node power distribution system connected with a DG.

### DETAILED DESCRIPTION OF THE INVENTION

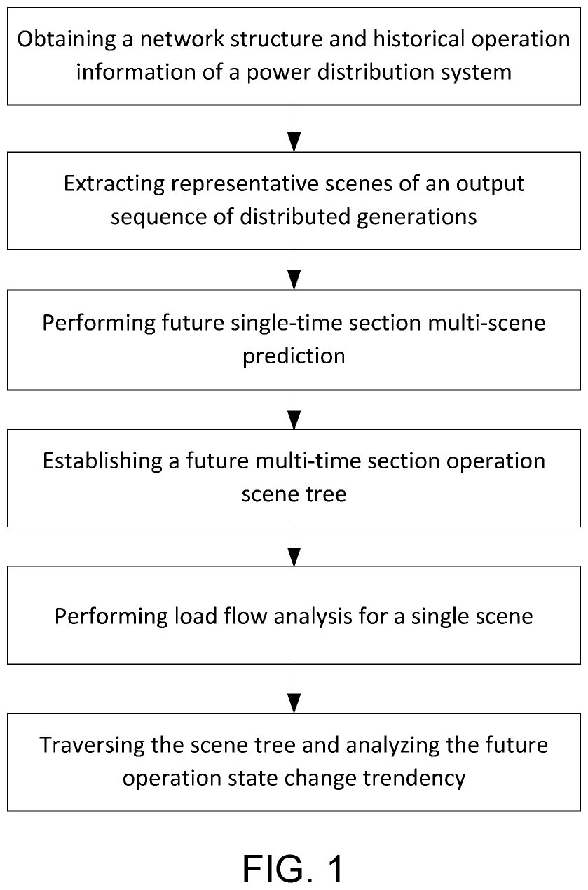

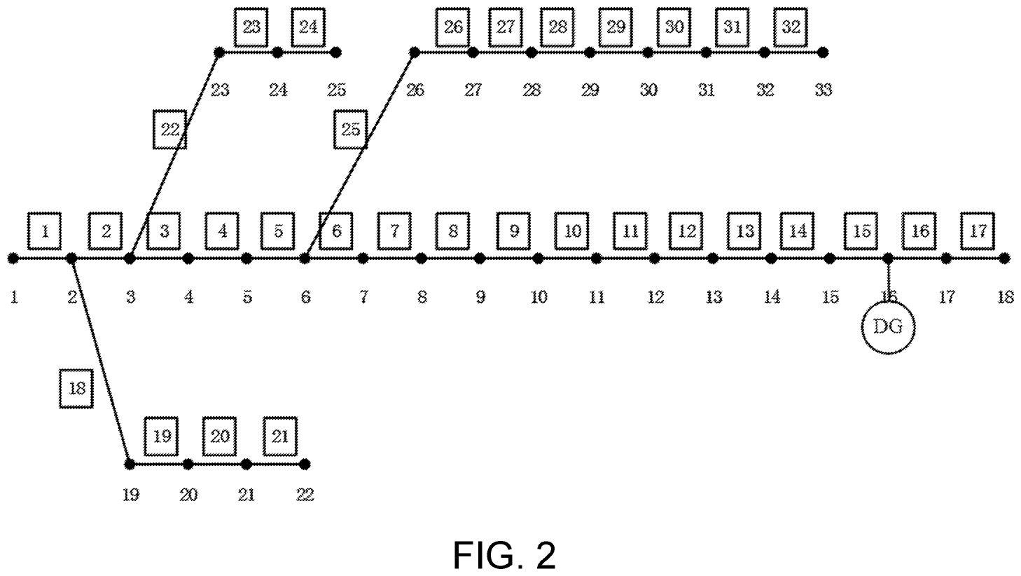

As shown in FIG. 1, the present invention provides a method for predicting an operation state of a power distribution network with DGs based on scene analysis, FIG. 2 is an IEEE-33 node power distribution system connected with the DGs, the voltage amplitude and phase angle of the balance node, the load of each PQ node and the voltage amplitude of each PV node in the network are given, and the historical output information of the DGs connected into the system is known (output data is recorded every five minutes). For the purpose of making objectives, technical schemes and advantages of the present invention more clear, deep and detailed explanation will be made to the present invention by combining drawings and the embodiment. It should be understood that the specific embodiment described herein is merely used for illustrating the present invention, but not intended to limit the present invention.

step 10) The network structure of the power distribution system is obtained, node numbering is performed by traversing the network, the type of each node and interconnected positions of the DGs are obtained, and as shown in FIG. 2, the historical output sequences of the DGs and the historical demand information of each load point are obtained.

step 20) According to the historical output sequences of the DGs, representative scene sequences of output of the DGs is extracted, and the specific steps are as follows:

step 201) here, the operation state of the power distribution system in the future two hours needs to be predicted with a prediction interval of fifteen minutes, supposing that the current time is 12:00 a.m., Jun. 1, 2017, the output sequence fragments, from which the representative scene sequence fragments need to be extracted, of the DG include the output information of 10:05-14:00 from May 15 to June 18 in the past three years, and the length of each time sequence fragment is 48, and determining the number M of the needed representative scene sequence fragments as 5;

step 202) intercepting time sequence fragments with the length of 48, from which the representative scene sequence fragments are to be extracted, from the historical output sequence of the DG, and recording the number N as 105, so as to form a scene set;

step 203) calculating the occurrence probability p(cᵢ) of each scene sequence fragment in the scene set according to the following formula:

$$p ( {c}_{i} ) = \frac{1}{N} i = 1 , 2 , 3 , … N$$

in the formula, cᵢ represents the i-th scene sequence fragment in the scene set, and i is a scene sequence fragment number;

step 204) for each scene sequence fragment cᵢ, calculating the Kantorovich distance between the scene sequence fragment cᵢ and other scene sequence fragments according to the following formula, finding out the scene sequence fragment nearest to the scene sequence fragment cᵢ and marking it in the scene set to form a minimum scene distance matrix KD, and calculating a matrix element KD(i), corresponding to the scene sequence fragment cᵢ, in the KD according to the following formula:

KD(i)=min{∥cᵢ−cⱼ∥₂, j∈[1, 2, 3, . . . N], j≠i}, i∈[1, 2, 3, . . . N]

wherein cⱼ represents the j-th scene sequence fragment in the scene set, and j is a scene sequence fragment number;

step 205) for each scene sequence fragment cᵢ, multiplying the minimum scene distance corresponding to the scene sequence fragment cᵢ by the probability of the scene sequence fragment cᵢ so as to obtain a minimum scene probability distance corresponding to the scene sequence fragment cᵢ, finding out a scene sequence fragment with the smallest minimum probability distance in the scene set as a removed scene sequence fragment c*, and removing the removed scene sequence fragment c* from the scene set, wherein the removed scene sequence fragment c* is as follows:

c*=min{KD(i)*p(i)|i∈[1, 2, 3, . . . N]}

step 206) finding out the scene sequence fragment cⁿ nearest to the removed scene sequence fragment c*, and updating the probability p(cⁿ) of cⁿ according to the following formula:

p(cⁿ)=p(c*)+p(cⁿ)

step 207) setting the total number N of the scene sequence fragments as N−1, and if the total number N of the updated scene sequence fragments is M, ending the step 20), otherwise, returning to the step 204).

step 30) A multi-scene prediction result of a future single-time section is obtained through matching the historical similar scenes by calculating a dynamic time warping distance between a real-time output sequence and representative scenes of the DGs, and the specific steps are as follows:

step 301) calculating the dynamic time warping distance DTWₖ between the real-time output sequence R and the k-th representative scene sequence fragment Q of the DG based on five representative scene sequence fragments of the output sequence of the DG extracted in the step 20), wherein the specific calculation method is as follows:

setting the length l of the k-th representative scene sequence fragment Q as 24 (only the time sequence fragments of front 10:05-12:00 are calculated), and the length p of the real-time output sequence R of the DG as 24, that is, T={t₁, t₂, . . . tₗ}, and R={r₁,r₂, . . . rₚ},

constructing a distance matrix A with 24 rows and 24 columns, namely,

$$A = [ \begin{matrix}d ( {q}_{1} , {r}_{1} ) & d ( {q}_{1} , {r}_{2} ) & … & d ( {q}_{1} , {r}_{p} ) \\ d ( {q}_{2} , {r}_{1} ) & d ( {q}_{2} , {r}_{2} ) & … & d ( {q}_{2} , {r}_{p} ) \\ ⋮ & ⋮ & ⋱ & ⋮ \\ d ( {q}_{l} , {r}_{1} ) & d ( {q}_{l} , {r}_{2} ) & … & d ( {q}_{l} , {r}_{p} )\end{matrix} ]$$

$${a}_{f g} = d ( {q}_{f} , {r}_{g} ) = \sqrt{{( {q}_{f} - {r}_{g} )}^{2}}$$

$$\{ \begin{matrix}D ( < > , < > ) = 0 ; \\ D ( f , < > ) = D ( < > , g ) = ∞ ; \\ D ( 1 , 1 ) = {a}_{11} ; \\ D ( f , g ) = {a}_{fg} + min \{ \begin{matrix}D ( f - 1 , g - 1 ) , D ( f , g - 1 ) , \\ D ( f - 1 , g )\end{matrix} \}\end{matrix}$$

wherein f=2, 3, . . . , 24, g=2, 3, . . ., 24, and D(24, 24) is the minimum accumulated value of the distance matrix A, namely the shortest distance DTWₖ between the real-time output sequence R and the k-th representative scene sequence fragment Q of the DG; and

step 302) taking the reciprocals of the dynamic time warping distances and performing normalization treatment on the reciprocals to obtain the similarity of the real-time output sequence and the representative scene sequence fragments of the DG, taking the similarity as the occurrence probability of a corresponding prediction scene, and calculating an output predicted value Fₖ at 12:15 in the output sequence of the DG through the k-th representative scene sequence and the corresponding dynamic time warping distance DTWₖ, wherein M future predicted values form the multi-scene prediction result of the future single-time section (12:15, Jun. 1, 2017).

step 40) According to the multi-scene prediction result, a future multi-time section operation scene tree is established, and the specific steps are as follows:

step 401) incorporating the multi-scene prediction result (totally five scenes) of the future single-time section T=T₀=12:15, Jun. 1, 2017 generated in the step 30) into the output sequence of the DG, and conducting the step 30) again to perform multi-scene prediction work of a next time section T′=12:30, Jun. 1, 2017, wherein the prediction interval Δt is 15 min;

step 402) performing scene reduction for the multi-scene prediction result of the time section 12:30, Jun. 1, 2017, setting the scene sequence number M′ after reduction as 5 while there are U=M²=25 scenes before reduction, respectively calculating the Kantorovich distances among 25 scene sequences to form a minimum scene distance matrix KD′, and calculating a matrix element KD′(s), corresponding to the scene sequence cₛ, in the KD′ according to the following formula:

KD′(s)=min{∥cₛ−cₜ∥₂, t∈[1, 2, 3, . . . 25], t≠s}, s∈[1, 2, 3, . . . 25]

wherein cₛ and cₜ represent the s-th scene sequence and the t-th scene sequence in the real-time output sequence set, including the multi-scene prediction result of the time section 12:30, Jun. 1, 2017, of the DG respectively, and s and t are scene sequence numbers;

step 403) for each scene sequence cₛ, multiplying the minimum scene distance corresponding to the scene sequence cₛ by the probability of the scene sequence cₛ to obtain a minimum scene probability distance corresponding to the scene sequence cₛ, finding out a scene sequence with the smallest minimum scene probability distance in the scene set as a removed scene sequence c\hat{ }, and removing the removed scene sequence c\hat{ } from the scene set, wherein the removed scene sequence c\hat{ } is as follows:

c\hat{ }=min{KD′(s)*p(s)|s∈[1, 2, 3, . . . M²]}

finding out the scene sequence c^{m} nearest to the removed scene sequence c\hat{ }, and updating the probability p(c^{m}) of c^{m} according to the following formula:

p(c^{m})=p(c\hat{ })+p(c^{m})

step 404) setting the total number U of the scenes as U−1, and if the total number U of the updated scenes is M′, conducting the step 405), otherwise, returning to the step 402);

step 405) if T′=T₀+8*Δt, arranging the prediction results of all the time sections in sequence of time to generate the future multi-time section operation scene tree and end the step 40), otherwise, setting T=T′, T′=T+Δt, and M=M′, and returning to the step 401).

Step 50) All scenes in the future multi-time section operation scene tree are deeply traversed, power distribution network load flow analysis is performed on each scene, the line current out-of-limit risk and the busbar voltage out-of-limit risk of the power distribution network are calculated, a variation tendency of the line current and busbar voltage out-of-limit risks under continuous time sections is obtained, namely the future operation state variation tendency of the power distribution network with the DGs, and the specific steps are as follows:

step 501) deeply traversing the scenes in the future multi-time section operation scene tree, and sequentially searching father nodes, namely predicted values of the previous time, with the single-time section multi-scene predicted value generated by the last time of prediction of the future multi-time section operation scene tree as the starting point till to the root node so as to reversely generate the continuous time sections through the route;

regarding the predicted output values of the DG as negative loads under each scene, calculating the power distribution network load flow through forward-back substitution, and obtaining the line current and busbar voltage conditions;

initializing, specifically, giving the voltage of balance nodes, assigning a voltage initial value \dot{U}ᵢ⁽⁰⁾ for other PQ nodes of the whole network, and assigning a reactive input initial power Qᵢ⁽⁰⁾ for PV nodes;

calculating the operation power of each node:

Sᵢ⁽⁰⁾=S_{Li}+Uᵢ⁽⁰⁾²ŷᵢₒ Formula (1)

inferring forward step by step from the tail end of the network, and solving the power distribution of all branches of the whole network from the node voltage \dot{U}ⱼ⁽⁰⁾, wherein the forward inference process is as follows:

$${P}_{ij}^{( 1 )} = {P}_{j}^{( 0 )} + {\sum }_{k ∈ {C}_{j}} {P}_{jk}^{〈 1 )} + Δ {P}_{ij}^{( 1 )} \\ {Q}_{ij}^{( 1 )} = {Q}_{j}^{( 0 )} + {\sum }_{k ∈ {C}_{j}} {Q}_{jk}^{( 1 )} + Δ {Q}_{ij}^{( 1 )} \qquad Formula ( 2 )$$

inferring backward hop by hop from the initial end, and solving the voltage \dot{U}ᵢ⁽¹⁾ of each node through the power of each branch:

$${U}_{j} = \sqrt{{( {U}_{j}^{( 1 )} - \frac{{P}_{ij}^{( 1 )} {R}_{ij} + {Q}_{ij}^{( 1 )} {X}_{ij}}{{U}_{j}^{( 1 )}} )}^{2} + {( \frac{{P}_{ij}^{( 1 )} {X}_{ij} - {Q}_{ij}^{( 1 )} {R}_{ij}}{{U}_{i}^{( 1 )}} )}^{2}} \\ {θ}_{j}^{( 1 )} = {θ}_{j}^{( 1 )} - arctan \frac{\frac{{P}_{ij}^{( 1 )} {X}_{ij} - {Q}_{ij}^{( 1 )} {R}_{ij}}{{U}_{i}^{( 1 )}}}{{U}_{i}^{( 1 )} - \frac{{P}_{ij}^{( 1 )} {R}_{ij} + {Q}_{ij}^{( 1 )} {X}_{ij}}{{U}_{i}^{( 1 )}}} \qquad Formula ( 3 )$$

amending the voltage and reactive power of the PV nodes through the obtained voltage of the nodes:

$${\dot{U}}_{i}^{( 1 )} = {U}_{i}^{( 1 )} ∠ {θ}_{i}^{( 1 )} \\ {Q}_{i}^{〈 1 )} = {U}_{i}^{( 1 )} {\sum }_{j = 1}^{n} {U}_{j}^{( 1 )} ( {G}_{ij} sin {θ}_{ij}^{( 1 )} - {B}_{ij} cos {θ}_{ij}^{( 1 )} ) \qquad Formula ( 4 )$$

detecting whether convergence is obtained or not according to convergence criterion, taking the voltage calculated value of each node as the new initial value to be substituted into Formula (2) if not meet the convergence condition, and starting to conduct next iteration;

$$\begin{matrix}\vert Δ {P}_{i}^{( 1 )} \vert < {ɛ}_{1} \\ \vert Δ {Q}_{i}^{( i )} \vert < {ɛ}_{1} & Formula ( 5 ) \\ Δ {P}_{i}^{( 1 )} = {P}_{is} - {U}_{i}^{( 1 )} {\sum }_{j = 1}^{n} {U}_{j}^{( 1 )} ( {G}_{ij} cos {θ}_{ij}^{( 1 )} + {B}_{ij} sin {θ}_{ij}^{( 1 )} ) \\ Δ {Q}_{i}^{( i )} = {Q}_{is} - {U}_{i}^{( 1 )} {\sum }_{j = 1}^{n} {U}_{1}^{( 1 )} ( {G}_{ij} sin {θ}_{ij}^{( 1 )} - {B}_{ij} cos {θ}_{ij}^{( 1 )} ) & Formula ( 6 )\end{matrix}$$

step 502) based on the load flow calculation result, calculating the line overload value L_{OL}, the line overload severity S_{OL}(C/E), the voltage out-of-limit value L_{OV} and the busbar overvoltage severity S_{OV}(C/E) under each scene, so as to obtain the line current out-of-limit risk OLR and the busbar voltage out-of-limit risk OVR of the power distribution network, wherein the line overload value L_{OL} is as follows:

L_{OL}=L−0.8

wherein L represents the proportion of current passing through the line to the rated current;

the above formula reflects the overload value of a single line, and the line overload risk is defined on this basis. The overload risk severity function S_{OL}(C/E) of equipment is defined. The current flowing through each line is set to determine the line overload risk severity. When the line current is less than or equal to 80% of the rated current, S_{OL}(C/E) is 0; along with increase of the current flowing through the line, S_{OL}(C/E) is increased, and the increase rate becomes faster;

the line overload severity is as follows:

S_{OL}(C/E)=e^{L}^{_{OL}}−1

the line current out-of-limit risk OLR is as follows:

$$O L R = {\sum }_{i = 1}^{N L} {S}_{O L} ( C / E )$$

wherein NL is the number of the lines of the whole network;

the voltage out-of-limit value L_{OV} is as follows:

L_{OV}=|1.05−V|

wherein Vis the per-unit value of node voltage;

the above formula reflects the voltage out-of-limit value of a single busbar, the voltage overload risk is defined on this basis, and the busbar overvoltage risk level of the whole area is evaluated. The voltage out-of-limit risk severity function of each busbar is defined as S_{OV}(C/E). When the voltage of each busbar is 1.05 p.u., the severity function is set as 0; along with increase of the voltage out-of-limit value, the voltage out-of-limit risk severity of each node is also increased;

the busbar overvoltage severity is as follows:

S_{OV}(C/E)=e^{L}^{_{OV}}−1

the busbar voltage out-of-limit risk OVR is as follows:

$$O V R = {\sum }_{i = 1}^{N P} {S}_{O V} ( C / E )$$

wherein NP is the number of nodes of the whole network;

step 503) sequentially arranging the calculation results of the step 502) from the time section T₀ to the nn-th time section to obtain the variation tendency of the line current and busbar voltage out-of-limit risks under the continuous time sections, namely the future operation state variation tendency of the power distribution network with the DGs.

The abovementioned embodiment is merely a preferred mode of execution of the present invention. It should be noted that a person of ordinary skill in the art may further make certain modifications and equivalent substitutions without departing from the conception of the present invention, and the technical schemes after modifications and equivalent substitutions for the claims of the present invention all fall within the protection scope of the present invention.

1. A method for predicting an operation state of a power distribution network with distributed generations (DGs) based on scene analysis, comprising the following steps:
step 10) obtaining a network structure and historical operation information of the power distribution system, wherein the historical operation information comprises historical output sequences of the DGs and historical demand information of each load point;
step 20) extracting representative scene sequence fragments of output of the DGs according to the historical output sequences of the DGs;
step 30) matching the real time scene with historical similar scenes by calculating a dynamic time warping distance between real-time output sequence fragments and the representative scene sequence fragments of the DGs, so as to obtain a multi-scene prediction result of a future single-time section T₀;
step 40) establishing a future multi-time section operation scene tree according to the multi-scene prediction result of the future single-time section; and
step 50) deeply traversing all scenes in the future multi-time section operation scene tree, performing a power distribution network load flow analysis for each scene, calculating a line current out-of-limit risk and a busbar voltage out-of-limit risk of the power distribution network, and obtaining a variation tendency of the line current and busbar voltage out-of-limit risks under continuous time sections, namely a future operation state variation tendency of the power distribution network with the DGs.

2. The method for predicting the operation state of the power distribution network with the DGs based on scene analysis according to claim 1, wherein in the step 10), node numbering is performed by traversing the power distribution network, so as to obtain a type of each node and interconnected positions of the DGs, thereby obtaining the network structure of the power distribution system.

3. The method for predicting the operation state of the power distribution network with the DGs based on scene analysis according to claim 1, wherein the specific process of the step 20) is as follows:
step 201) determining historical output sequence fragments, from which the representative scene sequence fragments need to be extracted, of the DG according to a prediction range of the operation state of the power distribution network, recording a length of the historical output sequence fragments as L, and determining a number M of the needed representative scene sequence fragments;
step 202) intercepting time sequence fragments with the length of L, from which the representative scene sequence fragments are to be extracted, from the historical output sequence fragments of the DG, and recording the number of the time sequence fragments as N, so as to form a scene set;
step 203) calculating an occurrence probability p(ci) of each scene sequence fragment in the scene set according to the following formula:
$$p ( {c}_{i} ) = \frac{1}{N}$$
$$i = 1 , 2 , 3 , … N$$
wherein in the formula, cᵢ represents a i-th scene sequence fragment in the scene set, and i is a scene sequence fragment number;
step 204) for each scene sequence fragment cᵢ, calculating Kantorovich distances between the scene sequence fragment cᵢ and other scene sequence fragments according to the following formula, finding out a scene sequence fragment nearest to the scene sequence fragment cᵢ and marking it in the scene set to form a minimum scene distance matrix KD, and calculating a matrix element KD(i), corresponding to the scene sequence fragment cᵢ, in the KD according to the following formula:
KD(i)=min{∥cᵢ−cⱼ∥₂, j∈[1, 2, 3, . . . N], j≠i}, i∈[1, 2, 3, . . . N]
wherein cⱼ represents a j-th scene sequence fragment in the scene set, and j is a scene sequence fragment number;
step 205) for each scene sequence fragment cᵢ, multiplying a minimum scene distance corresponding to the scene sequence fragment cᵢ by the occurrence probability of the scene sequence fragment cᵢ so as to obtain a minimum scene probability distance corresponding to the scene sequence fragment cᵢ, finding out a scene sequence fragment with a smallest minimum probability distance in the scene set as a removed scene sequence fragment c*, and removing the removed scene sequence fragment c* from the scene set, wherein the removed scene sequence fragment c* is as follows:
c*=min{KD(i)*p(i)|i∈[1, 2,3, . . . N]}
step 206) finding out a scene sequence fragment cⁿ nearest to the removed scene sequence fragment c*, and updating a probability p(cⁿ) of cⁿ according to the following formula:
p(cⁿ)=p(c*)+p(cⁿ)
step 207) setting a total number N of the scene sequence fragments as N−1, and if the total number N of updated scene sequence fragments is M ending the step 20), otherwise, returning to the step 204).

4. The method for predicting the operation state of the power distribution network with the DGs based on scene analysis according to claim 1, wherein the specific process of the step 30) is as follows:
step 301) calculating a dynamic time warping distance DTWₖ between a real-time output sequence and a k-th representative scene sequence fragment of the DG based on the representative scene sequence fragments of the historical output sequences of the DG extracted in the step 20); and
step 302) taking a reciprocal of the dynamic time warping distance and performing a normalization treatment on the reciprocal to obtain a similarity of the real-time output sequence and the k-th representative scene sequence fragment of the DG, taking the similarity as an occurrence probability of a corresponding prediction scene, and calculating a future predicted value Fₖ of the historical output sequences of the DG through the k-th representative scene sequence fragment and the corresponding dynamic time warping distance DTWₖ, wherein M future predicted values form the multi-scene prediction result of the future single-time section T₀.

5. The method for predicting the operation state of the power distribution network with the DGs based on scene analysis according to claim 1, wherein the specific process of the step 40) is as follows:
step 401) incorporating the multi-scene prediction result of the future single-time section T₀ generated in the step 30) into the real-time output sequence of the DG, and obtaining a multi-scene prediction result of a next time section T′=T₀+Δt in a manner the same as that in the step 30), wherein a total number U of the results is M² and Δt is a predicted interval;
step 402) performing a scene reduction for the multi-scene prediction result of the time section T′, setting a scene sequence number M′ of the time section T′ after reduction, respectively calculating Kantorovich distances among U scene sequences to form a minimum scene distance matrix KD′, and calculating a matrix element KD′(s), corresponding to a scene sequence cₛ, in the KD′ according to the following formula:
KD′(s)=min{∥cₛ−cₜ∥₂, t∈[1, 2, 3, . . . M²], t≠s}, s∈[1, 2, 3, . . . M²]
wherein cₛ and cₜ represent a s-th scene sequence and a t-th scene sequence in a real-time output sequence set, comprising a predicted value F of the time section T, of the DG respectively, and s and t are scene sequence numbers;
step 403) for each scene sequence cₛ, multiplying a minimum scene distance corresponding to the scene sequence cₛ by a probability of the scene sequence cₛ to obtain a minimum scene probability distance corresponding to the scene sequence cₛ, finding out a scene sequence with a smallest minimum probability distance in a scene set as a removed scene sequence c\hat{ }, and removing the removed scene sequence c\hat{ } from the scene set, wherein the removed scene sequence c\hat{ } is as follows:
c\hat{ }=min{KD′(s)*p(s)|s∈[1, 2, 3, . . . M²]}
finding out a scene sequence c^{m} nearest to the removed scene sequence c\hat{ }, and updating a probability p(c^{m}) of c^{m} according to the following formula:
p(c^{m})=p(c\hat{ })+p(c^{m})
step 404) setting a total number U of the scenes as U−1, and if the total number U of updated scenes is M′, conducting the step 405), otherwise, returning to the step 402); and
step 405) if T′=T₀+n*Δt, arranging the prediction results of all the time sections in sequence of time to generate the future multi-time section operation scene tree and ending the step 40), otherwise, setting T=T′, T′=T+Δ, and M=M′, and returning to the step 401), wherein n is a number of time sections needing predicting.

6. The method for predicting the operation state of the power distribution network with the DGs based on scene analysis according to claim 1, wherein the specific process of the step 50) is as follows:
step 501) deeply traversing the scenes in the future multi-time section operation scene tree, namely, regarding a predicted output value of the DG as a negative load under each scene, calculating the power distribution network load flow through forward-back substitution, and obtaining line current and busbar voltage conditions;
step 502) based on a load flow calculation result, calculating a line overload value L_{OL}, a line overload severity S_{OL}(C/E), a voltage out-of-limit value L_{OV} and a busbar overvoltage severity S_{OV}(C/E) under each scene respectively according to the following formulas, so as to obtain a line current out-of-limit risk OLR and a busbar voltage out-of-limit risk OVR of the power distribution network, wherein the line overload value L_{OL} is as follows:
L_{OL}=L−0.8
wherein L represents a proportion of current passing through a line to a rated current;
the line overload severity is as follows:
S_{OL}(C/E)=e^{L}^{_{OL}}−1
the line current out-of-limit risk OLR is as follows:
$$O L R = {\sum }_{i = 1}^{N L} {S}_{O L} ( C / E )$$
wherein NL is number of lines of a whole network;
the voltage out-of-limit value L_{OV} is as follows:
L_{OV}=|1.05−V|

wherein V is per-unit value of node voltage;
the busbar overvoltage severity is as follows:
S_{OV}(C/E)=e^{L}^{_{OV}}−1
the busbar voltage out-of-limit risk OVR is as follows:
$$OVR = {\sum }_{ι - 1}^{N P} {S}_{O V} ( C / E )$$
wherein NP is the number of nodes of the whole network; and
step 503) sequentially arranging the calculation results of the step 502) from the time section T₀ to the nn-th time section to obtain the variation tendency of the line current and busbar voltage out-of-limit risks under the continuous time sections, namely the future operation state variation tendency of the power distribution network with the DGs.

7. The method for predicting the operation state of the power distribution network with the DGs based on scene analysis according to claim 2, wherein the specific process of the step 30) is as follows:
step 301) calculating a dynamic time warping distance DTWₖ between a real-time output sequence and a k-th representative scene sequence fragment of the DG based on the representative scene sequence fragments of the historical output sequences of the DG extracted in the step 20); and
step 302) taking a reciprocal of the dynamic time warping distance and performing a normalization treatment on the reciprocal to obtain a similarity of the real-time output sequence and the k-th representative scene sequence fragment of the DG, taking the similarity as an occurrence probability of a corresponding prediction scene, and calculating a future predicted value Fₖ of the historical output sequences of the DG through the k-th representative scene sequence fragment and the corresponding dynamic time warping distance DTWₖ, wherein M future predicted values form the multi-scene prediction result of the future single-time section T₀.

8. The method for predicting the operation state of the power distribution network with the DGs based on scene analysis according to claim 3, wherein the specific process of the step 30) is as follows:
step 301) calculating a dynamic time warping distance DTWₖ between a real-time output sequence and a k-th representative scene sequence fragment of the DG based on the representative scene sequence fragments of the historical output sequences of the DG extracted in the step 20); and
step 302) taking a reciprocal of the dynamic time warping distance and performing a normalization treatment on the reciprocal to obtain a similarity of the real-time output sequence and the k-th representative scene sequence fragment of the DG, taking the similarity as an occurrence probability of a corresponding prediction scene, and calculating a future predicted value Fₖ of the historical output sequences of the DG through the k-th representative scene sequence fragment and the corresponding dynamic time warping distance DTWₖ, wherein M future predicted values form the multi-scene prediction result of the future single-time section T₀.

9. The method for predicting the operation state of the power distribution network with the DGs based on scene analysis according to claim 2, wherein the specific process of the step 40) is as follows:
step 401) incorporating the multi-scene prediction result of the future single-time section T₀ generated in the step 30) into the real-time output sequence of the DG, and obtaining a multi-scene prediction result of a next time section T′=T₀+Δt in a manner the same as that in the step 30), wherein a total number U of the results is M² and Δt is a predicted interval;
step 402) performing a scene reduction for the multi-scene prediction result of the time section T′, setting a scene sequence number M′ of the time section T′ after reduction, respectively calculating Kantorovich distances among U scene sequences to form a minimum scene distance matrix KD′, and calculating a matrix element KD′(s), corresponding to a scene sequence cₛ, in the KD′ according to the following formula:
KD′(s)=min{∥cₛ−cₜ∥₂, t∈[1, 2, 3, . . . M²], t≠s}, s∈[1, 2, 3, . . . M²]
wherein cₛ and cₜrepresent a s-th scene sequence and a t-th scene sequence in a real-time output sequence set, comprising a predicted value F of the time section T, of the DG respectively, and s and t are scene sequence numbers;
step 403) for each scene sequence cₛ, multiplying a minimum scene distance corresponding to the scene sequence cₛ by a probability of the scene sequence cₛ to obtain a minimum scene probability distance corresponding to the scene sequence cₛ, finding out a scene sequence with a smallest minimum probability distance in a scene set as a removed scene sequence c\hat{ }, and removing the removed scene sequence c\hat{ } from the scene set, wherein the removed scene sequence c\hat{ } is as follows:
c\hat{ }=min{KD′(s)*p(s)|s∈[1, 2, 3, . . . M²]}
finding out a scene sequence c^{m} nearest to the removed scene sequence c\hat{ }, and updating a probability p(c^{m}) of c^{m} according to the following formula:
p(c^{m})=p(c\hat{ })+p(c^{m})
step 404) setting a total number U of the scenes as U−1, and if the total number U of updated scenes is M′, conducting the step 405), otherwise, returning to the step 402); and
step 405) if T′=T₀+n*Δt, arranging the prediction results of all the time sections in sequence of time to generate the future multi-time section operation scene tree and ending the step 40), otherwise, setting T=T′, T′=T+Δt, and M=M′, and returning to the step 401), wherein n is a number of time sections needing predicting.

10. The method for predicting the operation state of the power distribution network with the DGs based on scene analysis according to claim 3, wherein the specific process of the step 40) is as follows:
step 401) incorporating the multi-scene prediction result of the future single-time section T₀ generated in the step 30) into the real-time output sequence of the DG, and obtaining a multi-scene prediction result of a next time section T′=T₀+Δt in a manner the same as that in the step 30), wherein a total number U of the results is M² and Δt is a predicted interval;
step 402) performing a scene reduction for the multi-scene prediction result of the time section T′, setting a scene sequence number M′ of the time section T′ after reduction, respectively calculating Kantorovich distances among U scene sequences to form a minimum scene distance matrix KD′, and calculating a matrix element KD′(s), corresponding to a scene sequence cs, in the KD′ according to the following formula:
KD′(s)=min{∥cₛ−cₜ∥₂, t∈[1, 2, 3, . . . M²], t≠s}, s∈[1, 2, 3, . . . M²]
wherein cₛ and cₜ represent a s-th scene sequence and a t-th scene sequence in a real-time output sequence set, comprising a predicted value F of the time section T, of the DG respectively, and s and t are scene sequence numbers;
step 403) for each scene sequence cₛ, multiplying a minimum scene distance corresponding to the scene sequence cₛ by a probability of the scene sequence cₛ to obtain a minimum scene probability distance corresponding to the scene sequence cₛ, finding out a scene sequence with a smallest minimum probability distance in a scene set as a removed scene sequence c\hat{ }, and removing the removed scene sequence c\hat{ } from the scene set, wherein the removed scene sequence \hat{ } is as follows:
c\hat{ }=min{KD′(s)*p(s)|s∈[1, 2, 3, . . . M²]}
finding out a scene sequence c^{m} nearest to the removed scene sequence c\hat{ }, and updating a probability p(c^{m}) of c^{m} according to the following formula:
p(c^{m})=p(c\hat{ })+p(c^{m})
step 404) setting a total number U of the scenes as U−1, and if the total number U of updated scenes is M′, conducting the step 405), otherwise, returning to the step 402); and
step 405) if T′=T₀+n*Δt, arranging the prediction results of all the time sections in sequence of time to generate the future multi-time section operation scene tree and ending the step 40), otherwise, setting T=T′, T′=T+Δt, and M=M′, and returning to the step 401), wherein n is a number of time sections needing predicting.

11. The method for predicting the operation state of the power distribution network with the DGs based on scene analysis according to claim 2, wherein the specific process of the step 50) is as follows:
step 501) deeply traversing the scenes in the future multi-time section operation scene tree, namely, regarding a predicted output value of the DG as a negative load under each scene, calculating the power distribution network load flow through forward-back substitution, and obtaining line current and busbar voltage conditions;
step 502) based on a load flow calculation result, calculating a line overload value L_{OL}, a line overload severity S_{OL}(C/E), a voltage out-of-limit value L_{OV} and a busbar overvoltage severity S_{OV}(C/E) under each scene respectively according to the following formulas, so as to obtain a line current out-of-limit risk OLR and a busbar voltage out-of-limit risk OVR of the power distribution network, wherein
the line overload value L_{OL} is as follows:
L_{OL}=L−0.8
wherein L represents a proportion of current passing through a line to a rated current;
the line overload severity is as follows:
S_{OL}(C/E)=e^{L}^{_{OL}}−1
the line current out-of-limit risk OLR is as follows:
$$O L R = {\sum }_{ι - 1}^{N L} {S}_{O L} ( C / E )$$
wherein NL is number of lines of a whole network;
the voltage out-of-limit value L_{OV} is as follows:
L_{OV}=|1.05−V|

wherein V is per-unit value of node voltage;
the busbar overvoltage severity is as follows:
S_{OV}(C/E)=e^{L}^{_{OV}}−1
the busbar voltage out-of-limit risk OVR is as follows:
$$O V R = {\sum }_{i = 1}^{N P} {S}_{O V} ( C l E )$$
wherein NP is the number of nodes of the whole network; and
step 503) sequentially arranging the calculation results of the step 502) from the time section T₀ to the nn-th time section to obtain the variation tendency of the line current and busbar voltage out-of-limit risks under the continuous time sections, namely the future operation state variation tendency of the power distribution network with the DGs.

12. The method for predicting the operation state of the power distribution network with the DGs based on scene analysis according to claim 3, wherein the specific process of the step 50) is as follows:
step 501) deeply traversing the scenes in the future multi-time section operation scene tree, namely, regarding a predicted output value of the DG as a negative load under each scene, calculating the power distribution network load flow through forward-back substitution, and obtaining line current and busbar voltage conditions;
step 502) based on a load flow calculation result, calculating a line overload value L_{OL}, a line overload severity S_{OL}(C/E), a voltage out-of-limit value L_{OV} and a busbar overvoltage severity S_{OV}(C/E) under each scene respectively according to the following formulas, so as to obtain a line current out-of-limit risk OLR and a busbar voltage out-of-limit risk OVR of the power distribution network, wherein
the line overload value L_{OL} is as follows:
L_{OL}=L−0.8
wherein L represents a proportion of current passing through a line to a rated current;
the line overload severity is as follows:
S_{OL}(C/E)=e^{L}^{_{OL}}−1
the line current out-of-limit risk OLR is as follows:
$$O L R = {\sum }_{i = 1}^{N L} {S}_{O L} ( C / E )$$
wherein NL is number of lines of a whole network;
the voltage out-of-limit value L_{OV} is as follows:
L_{OV}=|1.05−V|

wherein V is per-unit value of node voltage;
the busbar overvoltage severity is as follows:
S_{OV}(C/E)=e^{L}^{_{OV}}−1
the busbar voltage out-of-limit risk OVR is as follows:
$$O V R = {\sum }_{i = 1}^{N P} {S}_{O V} ( C / E )$$
wherein NP is the number of nodes of the whole network; and
step 503) sequentially arranging the calculation results of the step 502) from the time section T₀ to the nn-th time section to obtain the variation tendency of the line current and busbar voltage out-of-limit risks under the continuous time sections, namely the future operation state variation tendency of the power distribution network with the DGs.
